(19) United States
(12) Patent Application Publication
(10) Pub. No.: US 2012/0255575 A1
(43) Pub. Date: Oct. 11, 2012

(54) Dissolving Microwave Cleaner

(76) Inventor: Nancy Hanson, Newman Lake, WA (US)

(21) Appl. No.: 13/432,187

(22) Filed: Mar. 28, 2012

Related U.S. Application Data
(60) Provisional application No. 61/473,282, filed on Apr. 8, 2011.

(51) Int. Cl. B08B 9/08; B08B 7/04; C11D 3/60; B08B 1/00

(52) U.S. Cl. 134/1; 510/234

(57) ABSTRACT

A product and process for cleaning the interior surfaces of a microwave oven. Specifically, using a phosphate free dissolving tablet as an efficient and effective product for the removal of debris, dirt, film, and/or buildup from surfaces within the interior of the microwave oven

### CROSS-REFERENCE TO RELATED APPLICATIONS

The present application is related to and claims the benefit to U.S. Provisional Patent Application No. 61/473282 entitled “Dissolving Microwave Cleaner” naming Nancy Hanson as inventor, filed on Apr. 8, 2011.

### BACKGROUND

Different compositions are available for cleaning the interior surfaces of a microwave oven. The known compositions are generally in a liquid form and require excessive scrubbing to effectively remove food and debris from the desired area.

### BRIEF DESCRIPTION OF THE DRAWINGS

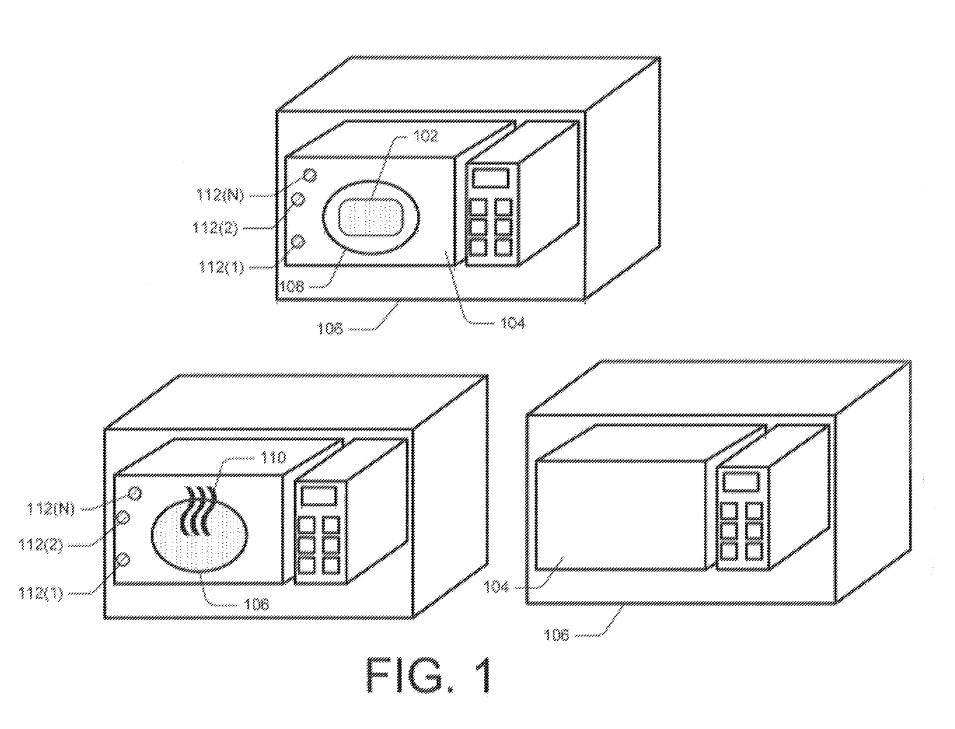

Other features and advantages will become apparent from the description below. The detailed description is illustrative and non-limiting and should be read with reference to the FIG. 1, an illustrative use of a dissolving tablet in a microwave oven.

### DETAILED DESCRIPTION

Some implementations herein provide a product and process for cleaning the interior surfaces of a microwave oven. Specifically, using a phosphate free dissolving tablet as an efficient and effective product for the removal of debris, dirt, film, and/or buildup from surfaces within the interior of the microwave oven. While the detailed description which follows refers to a dissolving tablet for use with a microwave oven, it is to be appreciated by one skilled in the art that the tablet may be used in other environments as well.

A phosphate free dissolving tablet 102 is used to clean the interior surfaces 104 of the microwave oven 106. The phosphate free dissolving tablet is manufactured to include, for example, any combination of, an enzymatic system, a bleaching agent, a protective agent, a binding agent, a scent extract, and/or a surfactant. It is however to be appreciated that any suitable combination of chemicals may be used. In one implementation, the formulation of the dissolving tablet includes a mixture of any of the above listed components. In another implementation, the components may be formulated in one or more layers making up the dissolving tablet where each layer may include only one component or may include any combination thereof.

The phosphate free dissolving tablet is placed into a microwave safe dish 108. The microwave safe dish is placed into the microwave oven 106 for a period of time adequate to dissolve the tablet. In one implementation, an amount of water or other dissolving liquid is added to the microwave safe dish to aid in the dissolution process.

In today's market there are a variety of microwaves with a variety of power and/or size. For example, generally a compact microwave may rate between 500 to 1000 watts, while a large capacity microwave generally uses over 2000 watts. Therefore, the dissolution time will be dependent upon on at least the chemical formulation of the phosphate free dissolving tablet as well as the wattage of the microwave. For example, a compact microwave may take longer to dissolve a phosphate free dissolving tablet with a given formulation than a large capacity microwave.

During the dissolution process, a vapor 110 is discharged, coating the interior surfaces 104 of the microwave oven 106 with the chemical formulation described above. In one implementation, after the tablet is completely dissolved and prior to removal of the chemical coating on the interior surfaces of the microwave, an additional time period, for example two minutes, is used to remove additional debris, dirt, film, and/or buildup 112(1)-112(N). Following the dissolution process, the chemical coating on the interior surfaces may be removed by wiping it off with a cloth, resulting in a debris free interior surface 110 within the microwave oven 106. Furthermore, the use of the scent extract, as described above, leaves the microwave oven with a pleasant odor. For example, the scent extract may include, without limitation, a lemon scent, a lime scent, an orange scent, or any combination thereof.

What is claimed is:

1. A method for dissolution of a cleaning tablet, the method comprising:
placing a cleaning tablet in a microwave safe dish in a microwave oven;
inputting and starting a first time setting on a microwave oven control panel, wherein the first time setting enables the cleaning tablet to completely dissolve and discharge a layer to coat and clean one or more interior surfaces of the microwave oven;
inputting and starting a second time setting on the microwave oven control panel to further facilitate coating and cleaning the one or more interior surfaces of the microwave oven; and
wiping the one or more interior surfaces of the microwave oven to remove a debris, dirt, film, or buildup layer;

2. The method of claim 1, wherein the cleaning tablet is phosphate free.

3. The method of claim 1, wherein the cleaning tablet is formulated using one or more layered components.

4. A phosphate free dissolving tablet for cleaning a microwave, the tablet comprising:
one or more layers of components comprising:
an enzymatic system;
a bleaching agent;
a protective agent;
a binding agent;
a scent extract; and
a surfactant.

5. The tablet of claim 4, wherein the scent extract is a lemon scent, a lime scent, an orange scent, or a combination thereof.

6. A dissolving tablet for cleaning a microwave, the tablet comprising:
one or more layers of components comprising:
an enzymatic system;
a bleaching agent;
a protective agent;
a binding agent;
a scent extract; and
a suractant.
